(19) United States
(12) Patent Application Publication
(10) Pub. No.: US 2014/0234547 A1
(43) Pub. Date: Aug. 21, 2014

(54) APPARATUS AND METHOD OF APPLYING LUBRICANT TO STEEL WIRE ROPES

(71) Applicant: Gilbarco AFS (Pty) Ltd., Johannesburg (ZA)

(72) Inventor: Colin Mckenzie, Johannesburg (ZA)

(73) Assignee: Gilbarco AFS (PTY) Ltd., Johannesburg (ZA)

(21) Appl. No.: 14/351,567

(22) PCT Filed: Oct. 16, 2012
(86) PCT No.: PCT/ZA2012/000069

§ 371 Date: Apr. 13, 2014

(30) Foreign Application Priority Data
Oct. 18, 2011 (ZA) 2011/8002

(51) Int. Cl. F16N 7/34

(52) U.S. Cl. CPC F16N 7/34
USPC 427/427.1; 118/325; 118/307; 118/712; 118/75

(57) ABSTRACT

An apparatus and method of applying lubricant to steel wire ropes, wherein the apparatus comprises a plurality of nozzles directed centrally towards a rope segment, the nozzles are connected to a compressor and a lubricant reservoir for enabling the dispensing of the lubricant therefrom. The apparatus is remotely controllable allowing quality, quantity and sequence of lubricant dispensed to be activated or deactivated remotely.

The present invention relates to an apparatus and method of applying lubricant with a high viscosity to steel wire ropes.

### BACKGROUND

Steel wire ropes are typically used in mineshaft lift assemblies. These ropes are placed under extreme pressures and environmental conditions, which lead to their decay and eventual need for replacement. To prolong the lifespan of such ropes, a lubricant is applied to the ropes.

Existing rope lubrication systems do however have several disadvantages. These include overly dispersed spray patterns, which lack a focused spray pattern and result in a high level of lubricant wastage. These systems are typically manually controlled resulting in inconsistent application of the lubricant as well as inaccurate scheduling of the rope lubrication.

The lubricant used for steel wire ropes has high adhesive properties, which reduces atomization abilities of the lubricant and makes standard atomization systems ineffective. In an attempt to overcome such lubricant properties—lubricant systems have been developed around a specific composition-type of lubricant, which increases the difficulty of managing the system due to lubricant specificity. Existing systems commonly use a double-acting piston apparatus with an eccentric pump to atomize the lubricant. The resulting atomization is inconsistent which eventually inhibits the work ability of the system. So to, the utilization of compressed air with existing nozzle configurations has proved unsuitable for the industry needs. The aforementioned systems typically use compressed air which is susceptible to moisture entering the system and corrosion resulting therefrom. The corrosion causes contaminant ingress due to rust peeling off and blocking the system.

Another disadvantage associated with the prior art is the absence of a computerised activation management system, which automates and maintains a detailed operational history of the lubrication. The absence of such automation often results in rope maintenance failures.

A further disadvantage with the prior art, is the lack of modular lubricating systems enabled to lubricate a plurality of ropes simultaneously without the need for an entire lubricating system allocated to a rope.

The invention seeks to provide a rope lubricating system that at least partially ameliorates the disadvantages associated with the prior art.

### SUMMARY OF INVENTION

The invention provides an apparatus for applying lubricant to steel wire rope comprising a pressuring means for storing and dispensing lubricant under pressure, a lubricant dispensing nozzle assembly fluidly connected to the pressuring means, wherein the nozzle assembly comprises a first lubricant outlet leading into an atomization chamber, the chamber configured to create a plurality of lubricant streams which are channelled to collide and atomize, and a second dispensing outlet which channels and dispenses the atomized lubricant, in use. The atomization does not therefore occur at the point of being dispensed, rather in an atomization chamber.

Preferably the apparatus comprises a plurality of nozzle assemblies circumferentially spaced and focused towards a central axis point through which a rope passes. This ensures that the entire rope circumference receives lubricant when dispensed by the apparatus.

Preferably the dispensing outlet of the nozzle is adjustable to enable regulation of the lubricant spray pattern size and focus. The regulation of lubricant dispensed may also be adjusted by regulating the output pressure of the pressuring means.

Preferably the nozzle assembly is secured about a housing having a wheel assembly to facilitate wheeling the nozzle assembly into position around the rope to be lubricated.

Conveniently a plurality of nozzle assembly housings may be connected to the apparatus to enable lubrication of a plurality of ropes simultaneously.

Conveniently the housing is at least partially circumferentially walled and comprises a drip pan to collect residue lubricant. The residue lubricant is channelled into a storage container for re-use, alternately disposal. Accordingly, the lubricant is securely contained to minimize environmental contamination.

The apparatus comprises a computerised activation and monitoring means for regulating rope lubrication and monitoring the quality and frequency of the lubrication.

Conveniently the apparatus is enabled to be activated and monitored remotely ensuring lubrication is possible when desired.

Preferably the apparatus further comprises a high-pressure fluid dispenser for dispensing water to clean slurry off the rope prior to lubrication. Slurry cleaning would preferably be done below the point of lubrication while the rope is on the up-stroke. This would enable lubrication on both the up-stroke and down-stroke movement of the rope.

According to another aspect of the invention there is provided a method of lubricating steel wire ropes comprising the steps of:
securing a rope lubricating apparatus around the steel wire rope where the apparatus comprises a pressuring means for storing and dispensing lubricant under pressure, a lubricant dispensing nozzle assembly fluidly connected to the pressuring means, wherein the nozzle assembly comprises a first lubricant outlet leading into an atomization chamber, the chamber configured to create a plurality of lubricant streams which are channelled to collide and atomize, in use and a second dispensing outlet which channels and dispenses the atomized lubricant; and
activating the apparatus to dispense lubricant.

Preferably the method comprises the steps of remotely activating and monitoring the apparatus.

Further features, variants and/or advantages of the invention will emerge from the following non-limiting description of an example of the invention.

### DETAILED DESCRIPTION OF THE INVENTION

The invention provides an automated apparatus for lubricating steel wire ropes typically used in mineshaft lift assemblies. The lubricant used needs to perform under extreme pressure conditions, in particular, the lubricant needs to maintain strong film integrity under great pressure. The lubricant also requires excellent tackiness qualities to minimise “fly-off” from high speed applications. An example of a suitable lubricant is the product known as Castrol 1060-68. Such lubricant also needs to be non-corrosive to both ferrous and non-ferrous metals and accordingly contain rust and oxidation inhibiting additives. It is the combination of aforementioned lubricant characteristics that have hampered the reliable and consistent functioning of existing lubricating systems.

The lubricating apparatus of the invention comprises a computerised activation and deactivation system, which is governed by preprogrammed and programmable criteria. The apparatus software enables the monitoring and adjustment of lubricating parameters thereby automatically maintaining complete historical data of the rope lubrication. Where multiple ropes are lubricated, the apparatus provides individual lubrication and monitoring services for each rope. The apparatus is further enabled to be remotely accessed, programmed, activated and monitored thereby providing real-time control over the apparatus.

The apparatus is enabled to monitor lubricant tank levels, lubricant daily usage volume, rope lube status, which information is displayed on an apparatus screen or a remote screen, as determined by the operator. Further apparatus features include a touch screen operation panel; a programmable schedule; a video feed per rope; a software update function; an integrated video feed of the rope and spray system; an alarm management and control, an active alarm management to indicate parameters such as low lubricant level, rope lube overdue, system status.

The lubricant applying apparatus of the invention comprises a pressuring means for storing and dispensing lubricant under pressure, a lubricant dispensing nozzle assembly fluidly connected to the pressuring means. The nozzles operate between 2 and 36 bar pressure and have a flow rate starting at 3 litres per minute. The nozzle assembly comprises a first lubricant outlet leading into an atomization chamber. At the point where the lubricant enters the chamber, it is forced about a needle configured to create multiple streams of lubricant. The lubricant streams are thereafter channelled and directed to collide with each other. The stream collision cause atomization of the lubricant. A second dispensing outlet then channels and dispenses the already atomized lubricant. The dispensing of pre-atomized lubricant enables the second outlet to dispense a consistent and focussed flow of lubricant, which provides an enhanced atomization at point of exit from the nozzle. The apparatus is also enabled to be used with nozzles having various aperture sizes and configurations. This allows the lubricant spray pattern and volume to be adjusted in combination with variable pressure settings.

The apparatus comprises a wheeled housing in which three nozzle assemblies are secured. The nozzle assemblies are connected to one another circumferentially about a circular pipe, which is in turn secured to the housing. The nozzles are spaced at approximately 120 degree angles from one another and relative to and facing towards the longitudinal central point of the housing. The housing and pipe have a cut-out section to receive a rope centrally. The housing is wheeled into position around the rope to be lubricated. The circular pipe is connected to the pressuring means by a second tube. In the same manner, a plurality of housing and nozzle assemblies may be connected to the apparatus for lubrication of multiple ropes.

The housing further comprises a conically shaped drip pan, which collects the residue dispensed lubricant from the internal wall of the housing. The residue lubricant is thereafter drained from the drip pan to a holding container. The lubricant may then be reused, alternately stored in a suitable container for disposal. Accordingly, the lubricant is securely contained to minimize environmental contamination.

The apparatus does not used compressed air, has a low flow rate and good atomization when compared to known prior art. Accordingly compressed air associated moisture is avoided thereby reducing the risk of corrosion and ingress contamination due to rust peeling off and blocking the nozzle. The apparatus also uses a filtration system comprising a one micron absolute filter and a kidney filtration system to further reduce the risk of contamination.

The invention is not limited to the precise details described above. Modifications may be made and other embodiments developed without departing from the spirit of the invention. For example the apparatus may be enabled to send warning notifications to an operator should notification criteria be reached during operation. The notifications may be sent via email, sms or other desirable communication methods. In another embodiment of the invention, the apparatus further comprises a high-pressure fluid dispenser for dispensing water to clean slurry off the rope prior to lubrication. Slurry cleaning would preferably be done below the point of lubrication while the rope is on the up-stroke. This would enable lubrication on both the up-stroke and down-stroke movement of the rope.

The claims and the summary of invention form an integral aspect of the description of the invention.

1. An apparatus for applying lubricant to steel wire rope comprising a pressuring means for storing and dispensing lubricant under pressure, a lubricant dispensing nozzle assembly fluidly connected to the pressuring means, wherein the nozzle assembly comprises a first lubricant outlet leading into an atomization chamber, the chamber configured to create a plurality of lubricant streams which are channelled to collide and atomize, and a second dispensing outlet which channels and dispenses the atomized lubricant, in use.

2. An apparatus as claimed in claim 1 comprising a plurality of nozzle assemblies circumferentially spaced and focused towards a central longitudinal axis.

3. An apparatus as claimed in claim 2, wherein the dispensing outlet of the nozzle is adjustable to enable regulation of the lubricant spray pattern size and focus.

4. An apparatus as claimed in claim 3, wherein the nozzle assembly is secured about a housing having a wheel assembly which is enabled to facilitate wheeling the housing and nozzle assembly into a desired position, in use.

5. An apparatus as claimed in claim 4, wherein a plurality of nozzle assembly housings are connectable to the apparatus.

6. An apparatus as claimed in claim 4, wherein the housing is at least partially circumferentially walled and comprises a drip pan to collect dispensed residue lubricant.

7. An apparatus as claimed in claim 2 comprising a computerised activation and monitoring means for regulating rope lubrication and monitoring the quality and frequency of the lubrication.

8. An apparatus as claimed in claim 7, wherein the apparatus is enabled to be activated and monitored remotely.

9. An apparatus as claimed in claim 2 comprising a high-pressure fluid dispenser for dispensing slurry cleaning fluid towards the rope, in use.

10. A method of lubricating steel wire ropes comprising the steps of:
securing a rope lubricating apparatus around the rope where the apparatus comprises a pressuring means for storing and dispensing lubricant under pressure, a lubricant dispensing nozzle assembly fluidly connected to the pressuring means, wherein the nozzle assembly comprises a first lubricant outlet leading into an atomization chamber, the chamber configured to create a plurality of lubricant streams which are channelled to collide and atomize, in use and a second dispensing outlet which channels and dispenses the atomized lubricant; and
activating the apparatus to dispense lubricant.

11. The method as claimed in claim 10, wherein the apparatus is remotely activated and lubrication monitored.
